(19) United States
(12) Patent Application Publication
(10) Pub. No.: US 2016/0294314 A1
(43) Pub. Date: Oct. 6, 2016

(54) Fractional Delay Adjustment in a Field-Oriented Control Architecture

(71) Applicant: Texas Instruments Incorporated, Dallas, TX (US)

(72) Inventors: Jorge Zambada, San Diego, CA (US); David Patrick Magee, Allen, TX (US)

(21) Appl. No.: 14/675,196

(22) Filed: Mar. 31, 2015

(51) Int. Cl. H02P 21/14; H02P 6/18

(52) U.S. Cl. CPC H02P 21/14; H02P 6/18

(57) ABSTRACT

A motor controller architecture and method of operating the same. The motor controller includes a function for selecting a fractional delay compensation value to be applied in the estimate of rotor position for which pulse-width-modulated drive signals are to be applied to a multi-phase electric motor. The motor is operated over iterated trial values of fractional delay time, while monitoring a magnitude of a feedback signal in the control loop. The selected fractional delay time is that having a lowest magnitude of the monitored feedback signal.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

This invention is in the field of control systems for electric machines. Embodiments described in this specification are more specifically directed to field-oriented control of electric motors.

Field-oriented control (“FOC”) has become commonplace in modern control systems for AC electric motors. According to this approach, stator windings of the AC motor are driven, for example by pulse-width-modulation, in such a way as to maximize the torque/ampere performance of the motor. Field-oriented control of AC motors is a complicated task because the rotation of the magnetic field in the stator with respect to the rotating magnetic field of the rotor can be asynchronous, such that characterization of the operation of the AC motor involves a set of differential equations with time varying coefficients.

Modern high-speed programmable microcontrollers have been widely adopted for carrying out the complex calculations required for accurate field-oriented control. Many AC motor control algorithms are based on the well-known “Park” transform, which transforms the applicable set of differential equations with angle-dependent coefficients into a set of differential equations that are independent of motor angle. In particular, the Park transform considers motor operation according to a rotating two-dimensional (d, q) coordinate system, where axis d is aligned with the field flux linkage component (i.e., the rotor flux) and orthogonal axis q is aligned with the torque component. By separating the field flux linkage and torque components, motor torque can be controlled without affecting the field flux. This enables the use of techniques such as dynamic torque control, proportional-and-integral (PI) control algorithms, and the like in the motor control loop.

FIG. 1 a illustrates a conventional FOC controller architecture for controlling the operation of an AC motor. In this architecture, speed controller function 10 is a control function that receives an external motor speed input signal \dot{θ}ref, along with a feedback rotor velocity estimate \dot{\hat{θ}}[n] from speed/position estimator 18. Speed controller 10 typically applies a function, such as a proportional-integral control function, to a difference (i.e., error signal) between motor speed input signal \dot{θ}ref and velocity estimate signal \dot{\hat{θ}}[n] to generate quadrature phase reference current signal Iqref for application to error generator 2q. Error generator 2q subtracts quadrature phase feedback current Iq from quadrature phase reference current signal Iqref, to produce error signal εq that is applied to proportional-integral (PI) controller 4q. Similarly, error generator 2d receives direct phase reference current Idref and direct phase feedback current Id, and produces error signal at that is applied to proportional-integral (PI) controller 4d. PI controllers 4q, 4d each apply a conventional control function, for example a combination of proportional and integral functions, to error signals εq, εd, respectively, to produce corresponding respective direct phase control signal Vd and quadrature phase control signal Vq, both of which are applied to inverse Park transform function 5. Inverse Park transform function 5 transforms the d and q phase control signals Vd, Vq to spatially fixed α and β phase control signals Vα, Vβ, and applies those signals to space vector generator 7, which in turn produces three-phase data signals Ta, Tb, Tc that express duty cycles (i.e., pulse widths) for corresponding motor phases; these data signals are applied to PWM drivers 8 that generate the pulses applied to the stator windings of motor M via power driver 9 and inverter 11. PWM drivers 8 commonly include timers that control the start and stop times of each drive pulse, in response to data signals Ta, Tb, Tc.

The feedback side of the control loop in this architecture receives feedback signals from multiple sources, all such sources based on sensors at motor M and corresponding sense circuits 13. One source of feedback signals is a set of current sample streams Iabc produced by ADCs 14a based on output from sense circuits 13, and which represent currents induced in the stator windings by the rotor of motor M as it rotates. Another set of feedback signals are voltage sample streams Vabc corresponding to voltages sensed at each of the stator windings, which are digitized by ADCs 14b. In addition, ADC 14c in this architecture receives a signal from the voltage supply source, and produces voltage sample stream Vbus corresponding to the voltage level of the reference bus. As typical in the art, current sample streams Iabc from ADC 14a are applied to Clarke transform function 16a to produce spatially fixed α and β phase feedback signals Iαβ, transforming the three-phase time variant system of differential equations into a two coordinate time variant system. These transformed feedback signals Iαβ are input to Park transform function 17a, which in turn produces direct and quadrature phase feedback currents Id, Iq, respectively. Similarly, voltage sample streams Vabc from ADC 26b are input to Clarke transform function 16b to produce spatially fixed α and β phase feedback signals Vαβ that are in turn input to Park transform function 17b, which produces direct and quadrature phase feedback voltages Vd and Vq. These direct and quadrature phase feedback currents Id, Iq, and corresponding direct and quadrature phase feedback voltages Vd, Vq, are applied to speed/position estimator function 18, which produces rotor position estimate \hat{θ}[n] and rotor velocity estimate \dot{\hat{θ}}[n] corresponding to the measurements acquired by ADCs 14a through 14c in sample period n (i.e., at time instant n·Tₛ, where Tₛ is the sample period of ADCs 14); this current rotor velocity estimate \dot{\hat{θ}}[n] is applied to speed controller function 10 as noted above. As known in the art, some conventional motor control systems use measurements of the rotor angle and speed, for example as produced by a quadrature encoder and resolver, rather than estimates based on the feedback signals as described above.

As known in the art, the Park transform calculations require knowledge of rotor position, i.e. rotor angle, in order to align the d axis to rotor flux. As such, in this conventional architecture of FIG. 1a, an estimate \hat{θ}[n] of the current rotor position for sample period n is produced by speed/position estimator 18 and applied to Park transform function 17a in the feedback loop. Inverse Park transform function 5 also requires some estimate of rotor position but, because it is involved in the generation of the phase drive signals for a next time interval (i.e., at sample time (n+1)·Tₛ), speed/position estimator 18 in this conventional architecture generates rotor position estimate \hat{θ}[n+1] for that next time interval n+1, and applies that estimate to inverse Park transform function 5. Conventionally, speed/position estimator 18 generates this forward-looking rotor position estimate \hat{θ}[n+1] multiplying the current rotor velocity estimate \dot{\hat{θ}}[n] by the sample period (Tₛ), and adding that increment in rotor position to current rotor position estimate \hat{θ}[n] to predict the rotor position at sample time (n+1)·Tₛ.

Because the inverse Park transform requires knowledge of the rotor position at the time that the drive signals are to be applied to accurately align the d phase control signal with rotor flux and the q phase control signal with the torque vector, the frame rotation error resulting from error in the estimate of the rotor position will cause the applied motor drive signals to erroneously drive the motor relative to the input control signals. This error will necessarily be reflected in the feedback signals for the next sample period, which in turn will produce the next output control signals based on erroneous rotor position estimate, and so on. At relatively low motor speeds, this error is insignificant. However, at higher motor speeds, this frame rotation error can degrade motor and system performance, and can even cause instability in the control system.

Modern motor control architectures, such as that shown in FIG. 1a, commonly deliver the drive commands in the form of pulse-width-modulated signals for each of the drive phases. As known in the art, these PWM signals are typically time-aligned at the midpoint of the sampling interval by PWM drivers 8, to optimally drive motor M as desired. FIG. 1b illustrates an example of the alignment of pulse-width modulated drive signals PWMa through PWMc for three phases of motor M. As shown in FIG. 1b, the midpoints of each of signals PWMa through PWMc are aligned at the midpoint time Tₛ/2 within each of sample periods n (i.e., between times nTₛ and (n+1)Tₛ) and n+1 (between times (n+1)Tₛ and (n+2)Tₛ). This alignment amounts to a half-period delay in the control loop between the time period for which the feedback loop of the controller of FIG. 1a determines the control signals of the current rotor velocity estimate \dot{\hat{θ}}[n] and feedback currents Id, Iq and the next time period for which the PWM signals are to be generated by PWM driver 8.

Conventional digital FOC architectures such as that shown in FIG. 1a operate in the discrete time domain, at a sampling frequency corresponding to period Tₛ. FIG. 1c illustrates an example of the relative timing of this sampled control loop. As shown in FIG. 1c, feedback signals including, for example, direct phase feedback voltage Vd[n*Tₛ] are acquired at time n*Tₛ, at the beginning of the n^{th} sample interval. Based on these feedback signal values acquired at that point in time, rotor position estimate \hat{θ}[n] and rotor velocity estimate \dot{\hat{θ}}[n] are used to generate output control signals to be applied in the next, n+1^{th}, sample interval at time (n+1)Tₛ. Those output control signals, as discussed above, are also based on an estimate of the rotor position at the time that those output control signals are to be applied. For example, the estimate of rotor position \hat{θ}[n+1] at sample time (n+1)Tₛ is typically produced from estimates of rotor position and rotor speed in the n^{th} sample interval n*Tₛ, for example as the sum of current rotor position estimate \hat{θ}[n] with the product of the current rotor velocity estimate \dot{\hat{θ}}[n] times the time interval Tₛ.

However, as discussed above relative to FIG. 1b, the PWM drive pulses are preferably time-aligned with one another, typically at the midpoint Tₛ/2 of the sample period. This time alignment of the PWM drive signals at midpoint Tₛ/2 means that a rotor position estimate \hat{θ}[n+1] at sample time (n+1)Tₛ will differ from what the rotor position would be at midpoint time (n+1)Tₛ+(Tₛ/2) at which time the PWM drive pulses are aligned, as shown in FIG. 1c. Application of rotor position estimate \hat{θ}[n+1] at sample time (n+1)Tₛ to the inverse Park transform will therefore not properly align the d axis with the rotor flux, and as such the resulting PWM drive signals would not accurately drive the motor phases as desired. This phase error in the estimate of rotor position is essentially a frame rotation error, in that the d axis of the drive signals will not be exactly aligned with the actual rotor flux.

By way of further background, Bae et al., “A Compensation Method for Time Delay of Full-Digital Synchronous Frame Current Regulator of PWM AC Drives”, describes an approach for compensating for the half-period delay resulting from alignment of the multi-phase PWM signals with one another within the sample period.

It has been observed, in connection with this invention, that the half-period delay to time-align the PWM pulses is not the only delay in the control system. Other system components, such as three-phase inverter 11 (FIG. 1a), have been observed to add significant delay to the control loop. These delays may vary from installation to installation, and may depend on the particular external components selected by the system integrator, such that compensation for these variable and implementation-dependent delays cannot necessarily be accounted for by conventional methods. At higher motor speeds at which the motor frequency is on the same order as the sampling frequency, frame rotation error caused by these additional delays can be sufficient to degrade motor and system performance and, in extreme cases, can result in oscillation of the control system. FIG. 1d illustrates an example of such oscillation in the operation of a motor in which phase error due to uncompensated delays in the control loop, for the example of a ramped increase in motor frequency from 500 RPM to 2500 RPM. As shown in this example, as the motor frequency stabilizes at the higher rotational rate, the phase error causes error in the motor drive signals. In this case, the phase error in one cycle is sufficient to cause the control loop to over-correct in the next cycle, with that overcorrection error over-corrected in the opposite direction in the following cycle, and so on, resulting in rapid oscillation of the motor speed between 1500 and 3500 RPM as shown in FIG. 1d.

### BRIEF SUMMARY OF THE INVENTION

One or more of the disclosed embodiments provide a controller architecture and corresponding control method capable of accurate and stable control of electric machines, such as an AC electric motor, even at high speed operation.

One or more of the disclosed embodiments provide such an architecture and method that can be implemented into existing control loops in a computationally efficient manner, and without requiring additional external circuitry or components.

One or more of the disclosed embodiments provide such an architecture and method in which field oriented control (FOC) can attain excellent stability even at high motor speeds.

Other objects and advantages of the disclosed embodiments will be apparent to those of ordinary skill in the art having reference to the following specification together with its drawings.

According to certain embodiments, the control architecture for an electric machine, and a corresponding control method, includes functionality that selects an appropriate fractional delay compensation for the control loop, specifically in calculating a rotor position estimate in a next sample period for which the output control signals are being generated. In one embodiment, the fractional delay compensation selection function applies varying fractional delay times to the rotor position estimate while monitoring the magnitude of a feedback signal. Based on the varying feedback signal magnitude with delay time, a fractional delay value is selected for use in the calculation of the rotor position estimate in the control loop during motor operation.

### BRIEF DESCRIPTION OF THE SEVERAL VIEWS OF THE DRAWING

FIG. 1a is a functional block diagram of a conventional motor controller architecture.

FIG. 1b is a timing diagram illustrating conventional alignment of pulse-width modulated (PWM) output control signals.

FIG. 1c is a timing diagram, in the discrete-time domain, illustrating an example of sampled and output signals in the architecture of FIG. 1a.

FIG. 1d is a plot of motor RPM versus time for a conventional motor control architecture.

FIG. 2 is a block diagram of a motor controller architecture according to an embodiment.

FIG. 3 is a functional block diagram of a digital portion of a microcontroller architecture for motor control according to the embodiment of FIG. 2.

FIGS. 4a and 4b are flow diagrams illustrating examples of the operation of the architecture of the embodiments of FIGS. 2 and 3.

FIGS. 5a and 5b are plots of a speed control input and a feedback signal magnitude, respectively, over time with increasing speed of a motor controlled by architecture of the embodiments of FIGS. 2 and 3.

FIG. 5c is a plot of maximum feedback signal magnitude versus fractional delay value as generated according to the embodiment of FIG. 4b.

FIG. 5d is a plot of motor RPM versus time exhibited by a motor control architecture according to an embodiment.

### DETAILED DESCRIPTION OF THE INVENTION

The one or more embodiments described in this specification are implemented into a control system for a permanent magnet synchronous motor (PMSM), more specifically in the context of field-oriented control (FOC) for such a motor, as it is contemplated that implementation of these embodiments is particularly advantageous in that context. However, it is also contemplated that concepts of this invention may be beneficially applied in other applications, for example AC induction motors and other types of AC motors and machines. Accordingly, it is to be understood that the following description is provided by way of example only, and is not intended to limit the true scope of this invention as claimed.

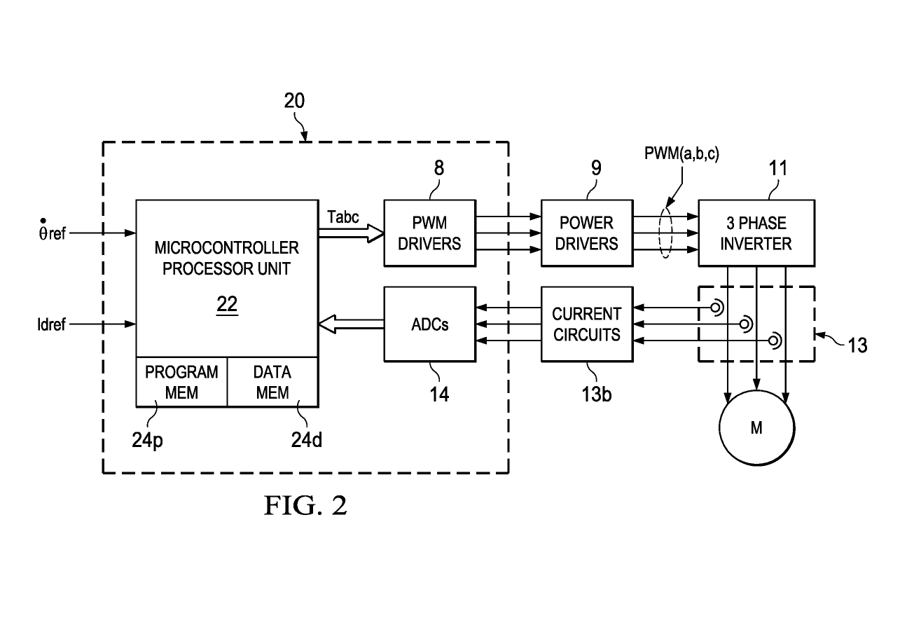

FIG. 2 illustrates, in the form of a block diagram, an example of a field-oriented control (FOC) control system for an electric machine, according to an embodiment. In the example of FIG. 2, the electric machine under control of this system is permanent magnet synchronous motor M, which has three stator windings arranged 120° out of phase relative to one another in the conventional manner. As will be apparent to those skilled in the art having reference to this specification, the number of phases in motor M may vary from the three phases shown in FIG. 2. In this embodiment, much of the control architecture is implemented by programmable microcontroller integrated circuit (MCU) 20, enabling many of the calculations and control loop functions to be carried out in the digital domain. Examples of integrated circuits suitable for use as MCU 20 according to these embodiments include microcontrollers in the C2000 and MSP430 families available from Texas Instruments Incorporated. In the example of FIG. 2, MCU 20 includes microcontroller processor unit 22, which receives direct phase reference current signal Idref and motor speed input signal \dot{θ}ref from external to MCU 20, along with feedback signals from motor M as will be described below. Processor unit 22 is coupled to program memory 24p, which stores program instructions for retrieval and execution by processor unit 22 upon the received reference and feedback signals; according to this embodiment, the program instructions stored in program memory 24p cause processor unit 22 to perform the various control functions described in this specification. Processor unit 22 is also coupled to data memory 24d, which stores data applied and calculated by processor unit 22 in its motor control operation. The result of this program execution by processor unit 22 are three-phase data signals Tabc indicative of the pulse-width-modulation duty cycles at which the three phases (i.e., phases a, b, c, respectively) of motor M are to be driven. Data signals Tabc are applied to PWM drivers 8 in MCU 20, which in turn generate output control signals that are applied to power driver circuits 9, which in turn generates the corresponding pulse-width-modulated pulses on lines PWM(a, b, c), at the appropriate frequency and phase that are applied to three-phase inverter 11 for driving motor M at the desired speed.

The feedback side of the control system of FIG. 2 includes current sensors 13 that in this example sense electrical conditions at each of the stators of motor M. As will be evident in the following description for this embodiment, these electrical conditions correspond to currents in the stator windings and to voltages indicative of the inductance of stator windings as a function of rotor position or rotor angle (the terms “rotor position” and “rotor angle” are used synonymously in this description). These sensed electrical parameters are, in this example, communicated to analog-to-digital-converters (ADCs) 14 in MCU 20 via conventional analog current circuits 13b. ADCs 14 in MCU 20 sample these signals at the frequency of sample clock Tₛ, to generate digital data values representative of the sensed electrical parameters at motor M. Those digital sampled values are then applied to processor unit 22 for processing according to the control algorithm expressed in program instructions stored in program memory 24p, which described in further detail below, to produce the appropriate drive signals to control motor M.

In the example of FIG. 2, PWM drivers 8 and ADCs 14 are implemented within MCU 20, i.e. in the same integrated circuit as processor unit 22. This integration of PWM drivers 8 and ADCs 14 thus follows the architecture of the C2000 MCUs noted above. Alternatively, PWM drivers 8 and ADCs 14 may be implemented “off-chip” relative to processor unit 22, as known in the art. Additionally, the example of FIG. 2 illustrates program memory 24p as also integrated into the same integrated circuit as processor unit 22; alternatively, program memory 24p may of course be implemented in a separate integrated circuit if desired. In any case, it is contemplated that other functions and interfaces of MCU 20, beyond those shown in FIG. 2, will be realized in the conventional manner, for example as appropriate for the C2000 and MSP430 MCU architectures noted above.

Further in the alternative, the functions of MCU 20 may be realized in other architectures, and are not necessarily implemented by a programmable logic device. For example, these functions may be realized in whole or in part as custom logic devices. It is contemplated that those skilled in the art having reference to this specification will be readily able to implement the controller functions described herein according to the circuitry desired for particular implementations.

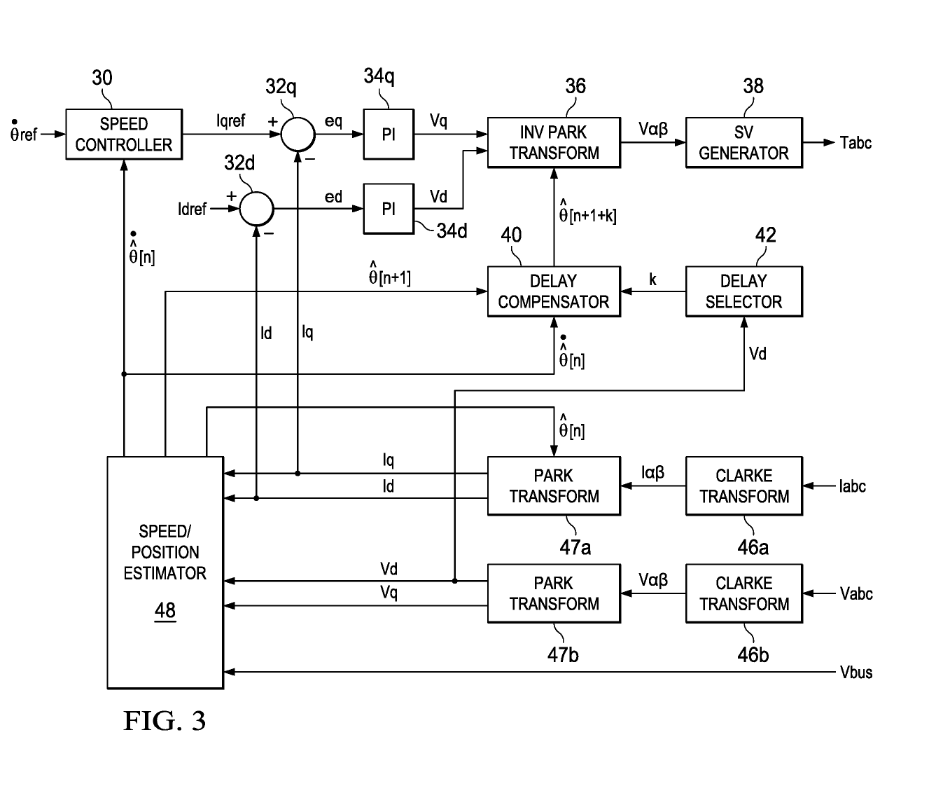

FIG. 3 illustrates the functional architecture of a field-oriented control (FOC) motor control system, for example as may be implemented within MCU 20 in the hardware architecture of FIG. 2, according to an embodiment. An external control signal \dot{θ}ref indicating the desired motor speed is received by speed controller 30, which also receives an estimate \dot{\hat{θ}}[n] of the current rotor velocity of motor M, as determined by the feedback loop portion of this architecture. Speed controller 30 generates quadrature phase reference current Iqref based on these two inputs, for example by applying a conventional control function. Quadrature phase reference current Iqref corresponds to the desired torque component (i.e., the q component in the d, q domain), and is applied to error generator 32q along with quadrature phase feedback current Iq. Error generator 32q generates quadrature phase error signal εq corresponding to the difference of quadrature phase reference and feedback currents Iqref, Iq, respectively, and which is applied to proportional-integral (PI) controller 34q. PI controller 34q applies a conventional control function (e.g., proportional-integral) to that quadrature phase error signal εq to produce quadrature phase control signal Vq, which is applied to inverse Park transform function 36. For the direct phase d component, error generator 32d similarly receives externally generated direct phase reference current Idref along with feedback current Id, and forwards error signal εd corresponding to the difference of those two currents to proportional-integral (PI) controller 34d. Controller 34d in turn applies a conventional control function, for example a combination of proportional and integral functions, to this error signal εd to produce direct phase control signal Vd for application to inverse Park transform function 36.

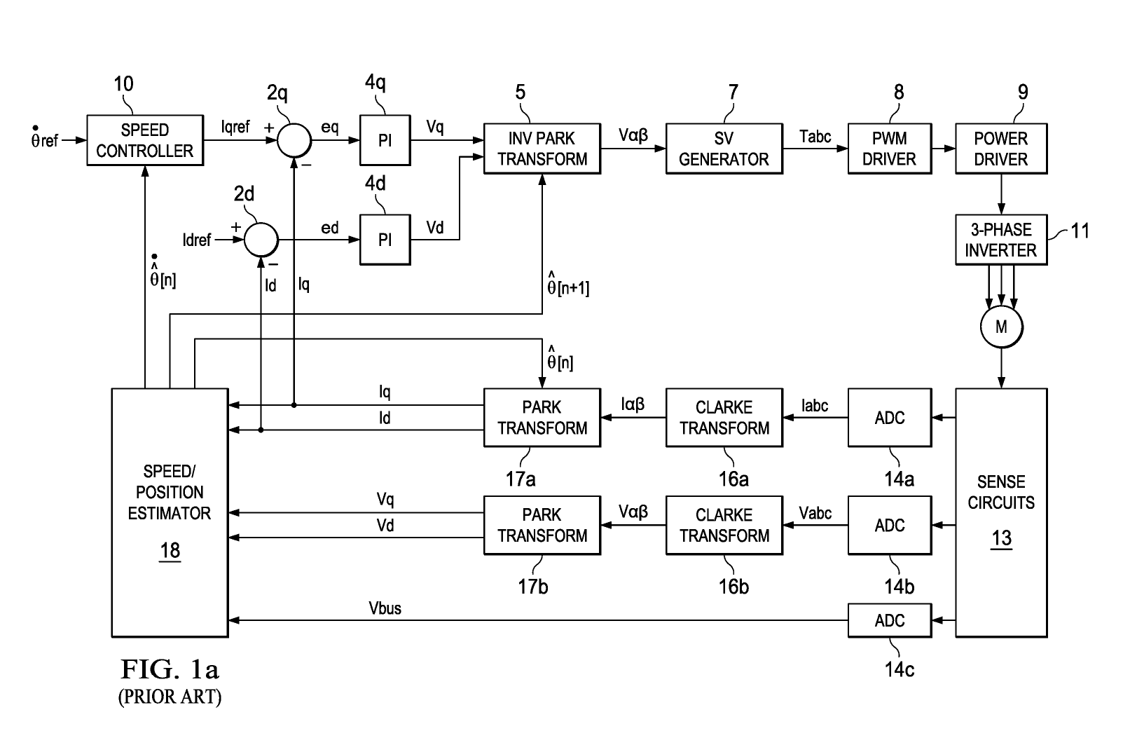

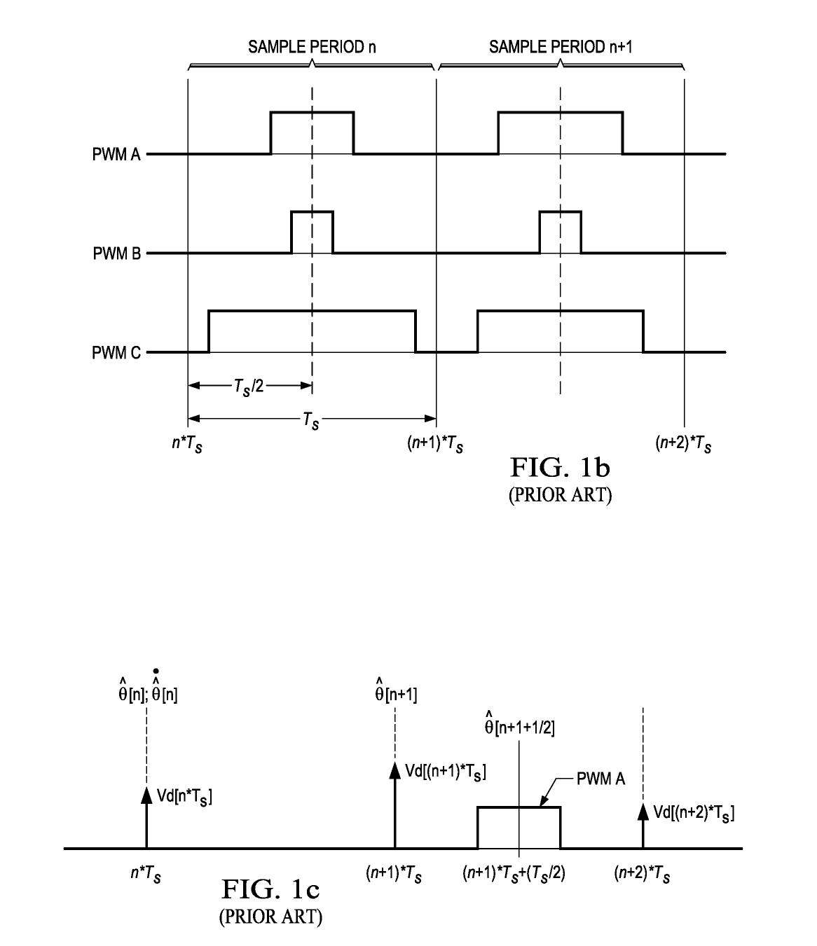

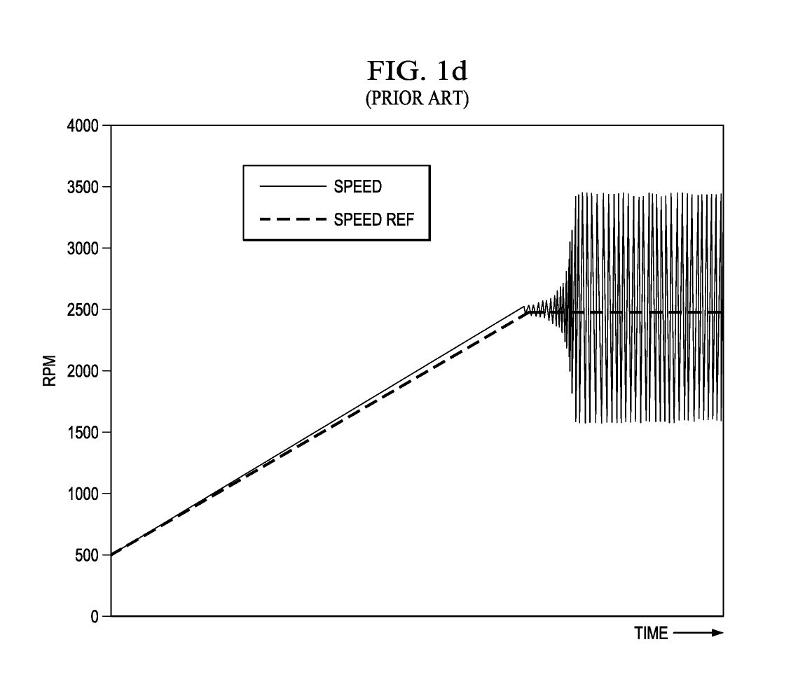

As described above relative to FIG. 1a, inverse Park transform function 35 transforms the d and q phase control signals Vd, Vq to spatially fixed α and β phase control signals Vαβ. That inverse Park transform requires knowledge of the rotor position (more specifically, the rotor flux or field flux linkage angle), which in this embodiment is supplied as rotor position estimate \hat{θ}[n+1+k]. The generation of this rotor position estimate according to this embodiment will be described in further detail below. As shown in FIG. 3, phase control signals Vαβ from inverse Park transform function 36 are applied to space vector generator 38, which produces three-phase data signals Tabc supplied to PWM drivers 8 (FIG. 2).

On the feedback side of the control loop in this architecture, Clarke transform function 46a receives sampled currents Iabc associated with the three motor phases and acquired for the current sample period n, as produced by ADCs 14 based on the electrical parameters sensed by sensors 11 (FIG. 2). This sample period n corresponds to the period at which control signals are generated and applied to motor M; the sample rate of ADCs 14 may differ (i.e., be a higher rate) than this control loop sample frequency. From these inputs, Clarke transform function 46a produces spatially fixed α and β phase feedback signals Iαβ, which in turn are applied to Park transform function 47a to produce d and q phase feedback signals Id, Iq, respectively. These feedback signals Id, Iq are applied to error generators 32d, 32q, respectively, as discussed above. Similarly, Clarke transform function 46b receives sampled voltages Vabc from ADCs 14, and produce α and β phase voltage feedback signals Vαβ, which are applied to Park transform function 47b to produce d and q phase voltage feedback signals Vd, Vq, respectively. Speed/position estimator function 48 receives current feedback signals Id, Iq and voltage feedback signals Vd, Vq as well as sensed bus voltage Vbus from ADCs 14. In this architecture of FIG. 3, speed/position estimator function 48 applies a conventional algorithm to produce rotor position estimate \hat{θ}[n] for the current sample period (i.e., that corresponding to the sampled sensed feedback currents and voltages, rotor velocity estimate \dot{\hat{θ}}[n] for that same current sample period, and forward-looking rotor position estimate \hat{θ}[n+1] for the next sample period, i.e. the sample period n+1 for which the output control signals Tabc are to be generated. Examples of motor control architectures including speed and position estimator algorithms and methods suitable for use as speed/position estimator function 48 in this embodiment are described in copending U.S. applications Ser. No. 14/337,576 and Ser. No. 14/337,595, both filed Jul. 22, 2014 and commonly assigned herewith. The rotor position estimate \hat{θ}[n] for the current sample period is applied to Park transform functions 47a, 47b, and the rotor velocity estimate \dot{\hat{θ}}[n] for the current sample period is applied to speed controller function 30 as described above.

As described above, the architecture of the FOC motor control system in the embodiment shown in FIG. 3 is a relatively high-performance architecture, as it generates its feedback signals Id, Iq, Vd, Vq from a relatively large set of sensor signals, namely three currents Iabc from three motor phases, three voltages Vabc from three voltage phases, and bus voltage Vbus. It is contemplated, however, that these embodiments may be implemented in other FOC motor control architectures, including those in which fewer sensor signals are sampled and applied to the feedback loop. For example, these embodiments may be implemented in a system based on two sampled currents (from two of the motor phases) and the bus voltage Vbus. In such architectures in which fewer sampled signals are obtained, it is contemplated that the necessary values for the other terms (e.g., voltages and currents for the other phases) may be estimated from the signal values that are sampled, as known in the art. Examples of such estimation include those in which one or two of three phase currents are measured, the other phase currents are estimated, the bus voltage Vbus is measured, and some or all of the three voltages Vabc are estimated; and those in which a bus current Ibus is measured, the phase currents are estimated, the bus voltage Vbus is measured, and some or all of the three voltages Vabc are estimated; among others. In any case, the control algorithm according to these embodiments does not require determination of the metric signal in a particular manner, so long as the appropriate feedback signals and metric signal can be determined.

Furthermore, in the alternative to speed/position estimator function 48 estimating the rotor position and velocity based on signals issued by sensors at the motor as described above, it is contemplated that these embodiments may utilize measurements of the angle and speed of the rotor provided by the appropriate sensors, such as a quadrature encoder and resolver. These sensors may provide an indication of the sensed state of the motor even if the rotor is currently stationary (i.e., not dependent on a back emf produced by rotation of the motor). Other sensors known in the art for providing measurements of the speed and angle of the rotor may alternatively be used in connection with these embodiments. According to this alternative, it is contemplated that a measured rotor position θ[n] and measured rotor velocity \dot{θ}[n] would be obtained for the current sample period n from these sensors and associated circuitry.

According to this embodiment, delay compensator function 40 in the functional architecture of MCU 20 produces delay-compensated rotor position estimate \hat{θ}[n+1+k] based on the values of rotor position estimate \hat{θ}[n+1] and rotor velocity estimate \dot{\hat{θ}}[n] produced by speed/position estimator function 48. Alternatively, if sensors such as a quadrature encoder and resolver are implemented in the system, delay compensator function 40 would produce delay-compensated rotor position estimate \hat{θ}[n+1+k] from the measured rotor position θ[n] and measured rotor velocity \dot{θ}[n] provided by such sensors. In either case, this delay-compensated rotor position estimate \hat{θ}[n+1+k] is an estimate of the rotor position for a point in time in the next sample period n+1 at which the output control signals Tabc are to be applied to motor M, specifically the point in time (fractional delay time k·Tₛ) within that next sample period indicated by fractional delay k. Fractional delay kin this embodiment is intended to include all delays in the control architecture that can affect the application of the drive signals to motor M, including the half-period (or other) delay for time-alignment of the pulse-width-modulated signals for the phases of motor M as described above relative to FIG. 1b, and other delays such as those presented by the components external to MCU 20 including power drivers 9 and three-phase inverter 11.

However, the particular value of fractional delay k is generally not known prior to assembly of the overall motor control system of FIG. 2. In particular, for implementations such as that shown in FIG. 2 in which the digital portion of the controller architecture is implemented within a digital logic circuit such as microcontroller processor unit 22, the fractional delay k that is to be involved in the generation of delay-compensated rotor position estimate \hat{θ}[n+1+k] cannot be known. According to the embodiments described in this specification, for example as shown in FIG. 3, delay selector function 42 is provided to determine the value of fractional delay k to be applied by delay compensator function 40. Delay selector function 42 operates at appropriate times during the operation of MCU 20, for example at power-up, to determine fractional delay value k based on one or more metric signals, for example voltage feedback signal Vd. This selected fractional delay value k is then communicated to delay compensator function 40 to use in the generation of delay-compensated rotor position estimate \hat{θ}[n+1+k] during control of the operation of motor M.

As mentioned above, it is contemplated that the digital controller architecture according to these embodiments, including the example of FIG. 3, will typically be realized by programmable digital logic such as microcontroller processor unit 22 shown in the arrangement of FIG. 2. In such an implementation, delay selector function 42 will be realized by program instructions stored in program memory 24p and executed by microcontroller processor unit 22 in conjunction with data memory 24d at power-up or at other times during its operation in the control of motor M. Alternatively, it is contemplated that delay selector function 42 may be realized by other digital logic as appropriate for the particular implementation of the functional architecture shown in FIG. 3 and described above for this embodiment. It is contemplated that those skilled in the art having reference to this specification will be readily able to realize the functionality of delay selector function 42 for various implementations, without undue experimentation.

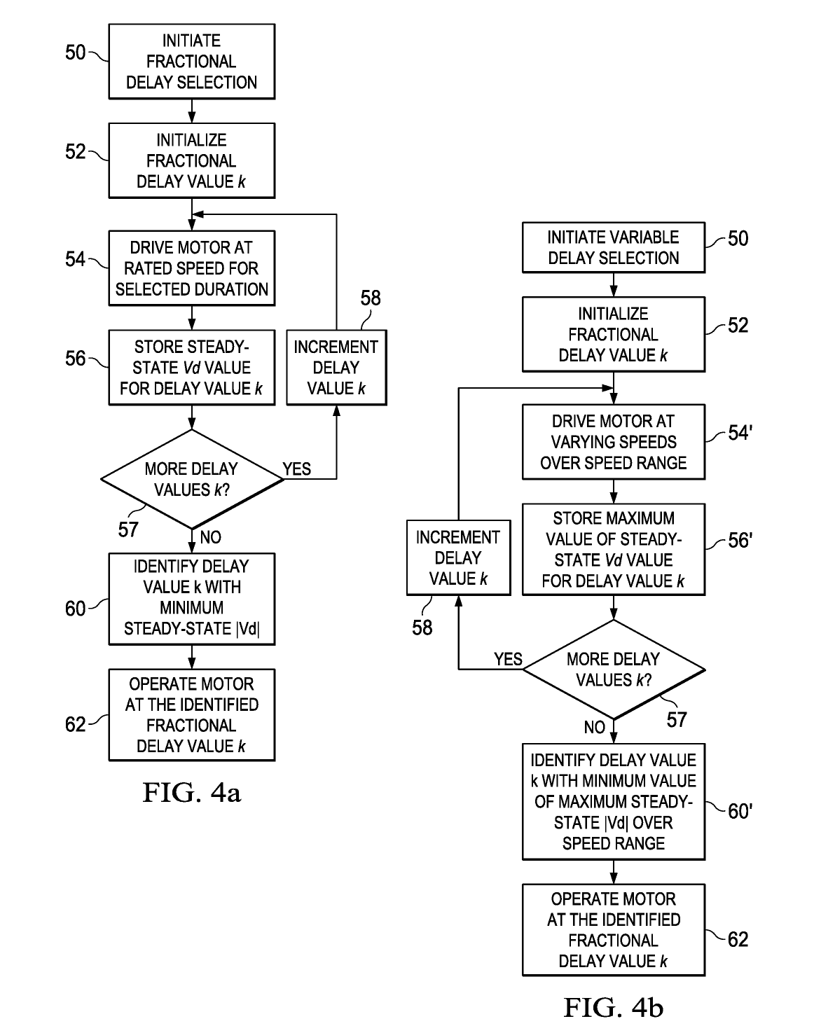

Referring now to FIG. 4a, a method of operation of delay selector function 42 in combination with the other functions of the architecture of FIG. 3, in determining and applying an appropriate value of fractional delay k to delay compensator function 40, will now be described in detail in connection with an embodiment. It is of course contemplated that variations to this embodiment will be apparent to those skilled in the art having reference to this specification.

The method of FIG. 4a begins with process 50, in which the selection of the desired fractional delay value k is initiated. It is contemplated that initiation process 50 will typically occur on power-up of the motor control system. However, it is also contemplated that initiation process 50 may be performed periodically during normal operation of the motor control system, or alternatively during operation in response to the motor control system detecting a change in conditions, loss of performance or stability, or the like. Following initiation process 50, fractional delay value k is set to an initial trial value in process 52. For the example in which time-alignment of the pulse-width-modulated drive signals as described above relative to FIG. 1b is implemented, a useful initial trial fractional delay value k may be set to 0.5 (corresponding to a fractional delay time of 0.5·Tₛ). This initial value of k=0.5 corresponds to the situation in which the only fractional delay is that due to time-alignment of the PWM pulses, with zero additional delay in the control loop. Once fractional delay value k is initialized in process 52, the motor control system is operated to drive motor M at a selected speed, for example its “rated” speed, for some duration of time, in process 54. During the operation of process 54, delay compensator function 40 (FIG. 3) applies a delay-compensated rotor position estimate \hat{θ}[n+1+k] with fractional delay value k at its current value, namely that initialized in process 52.

During the operation of motor M in process 54, a metric signal based on one or more of the feedback signals involved in the control of motor M during its operation are monitored, for example by delay selector function 42 itself. In the example of FIG. 3, the metric signal monitored by delay selector function during process 54 is feedback voltage signal Vd from Park transform 47b, and is a sampled signal indicating the state of motor M in the current sample period. It is contemplated that one of the direct (d) phase feedback signals is well-suited for monitoring in the selection of the fractional delay value k. In this embodiment, voltage feedback signal Vd is a suitable metric signal as its magnitude is effectively an error signal indicative of the difference between the actual state of the motor, sensed at the current sample period, and the desired state of the motor indicated by the control signals generated for that current sample period. Specifically, voltage feedback signal Vd reflects inaccuracy in the prediction of rotor position at which the drive signals are applied by inverter 11, with increasing magnitude of voltage feedback signal Vd corresponding to increased inaccuracy in that prediction. Alternatively, a different feedback signal or multiple feedback signals and characteristics may be monitored during the operation of motor M in process 42. Further in the alternative, the metric signal applied to delay selector function 42 may be a metric computed from a combination of several of the various feedback signals from motor M. Furthermore, the metric signal applied to delay selector function 42 may have a magnitude that increases with the error in the rotor position estimation, or decreases with the error in the rotor position estimate; this metric signal may also be a signed value to indicate the polarity of the error.

In any case, the duration of this operation of motor M in process 54 is preferably sufficiently long for the selected feedback signal or signals to reach some steady-state value at the desired motor speed. As such, process 54 may be performed for a pre-selected duration (a selected time, or a selected number of sample periods or iterations of the control loop) sufficient to reach that steady state, or alternatively the feedback signal may be monitored to detect the steady-state and thus the end of this duration. At that time, the steady-state magnitude of the monitored feedback signal (e.g., voltage feedback signal magnitude |Vd|) is stored in memory (e.g., data memory 24d) in association with the current trial fractional delay value k.

Decision 57 determines whether additional trial fractional delay values k remain to be tested. If so (decision 57 returns a “yes” result), fractional delay value k is incremented in process 58. Alternatively, of course, trial fractional delay value k may be decremented in process 58, or otherwise selected according to a binary search or other minimization technique. In any case, motor drive process 54 is repeated, with delay compensator function 40 applying a delay-compensated rotor position estimate \hat{θ}[n+1+k] at a next trial fractional delay value k. In this embodiment, motor M is stopped or slowed following each instance of process 54, and then ramped up in speed to its rated speed (or other selected speed, which may be a lower speed, a higher speed, or a mid-range speed of motor M) in each instance of process 54 following the application of the incremented trial fractional delay value k from process 58. Alternatively, it is contemplated that the incrementing of trial fractional delay value kin process 58 may be performed “on the fly”, with motor M continuously operated at its selected speed while fractional delay value k is adjusted. In any case, processes 54, 56, decision 57, and process 58 are repetitively performed at each trial fractional delay value k over the desired range of values.

In this embodiment, decision 57 may be performed simply by determining whether all trial fractional delay values k over a selected range of values have been applied. For example, the trial fractional delay values k may range from k=0.5 to k=0.6; of course, the particular range to be analyzed will depend on the relationship of the expected range of control loop delays to the sampling period Tₛ of the control loop. In any case, upon decision 57 determining that all trial fractional delay values k have been applied (decision 57 returns a “no” result), process 60 is then performed to identify an optimum value of fractional delay, for example the trial fractional delay value k having an extreme magnitude value of the metric signal monitored during process 54. This extreme magnitude value may be a minimum value or a maximum value, depending on the particular metric signal being monitored. For the case in which the monitored feedback signal is feedback voltage Vd, which has a magnitude that increases with increasing error in the prediction of rotor position as described above, process 60 identifies a fractional delay value k associated with the minimum steady-state magnitude of |Vd|.

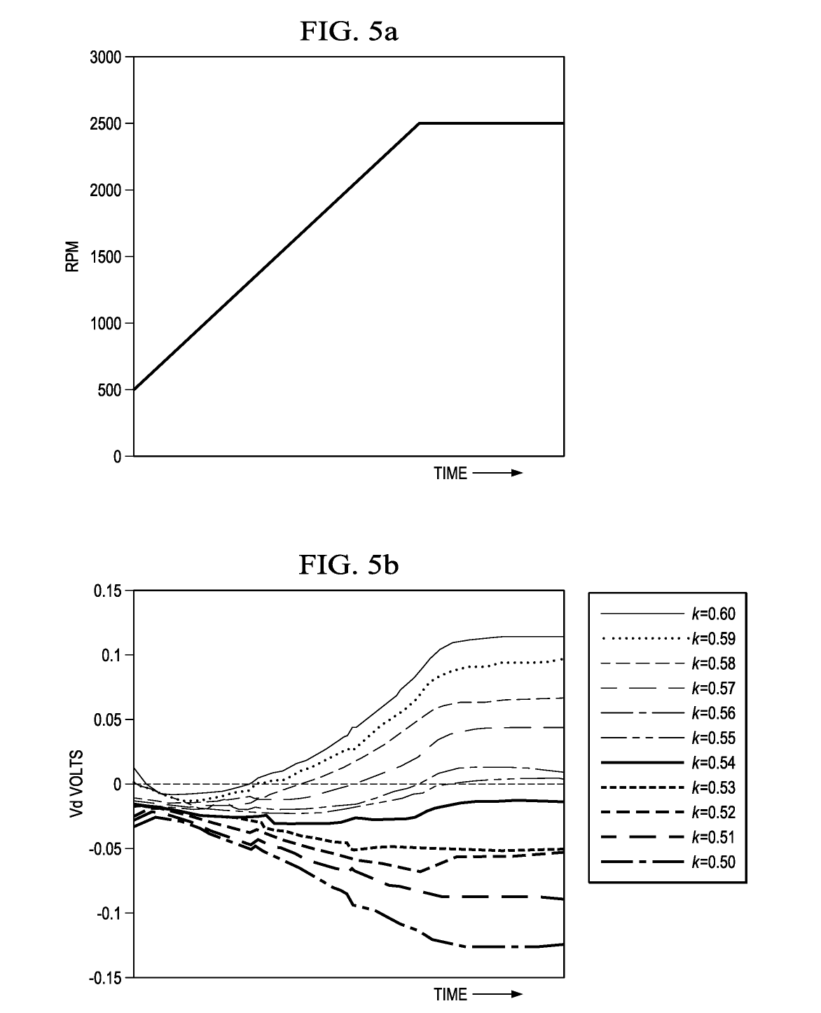

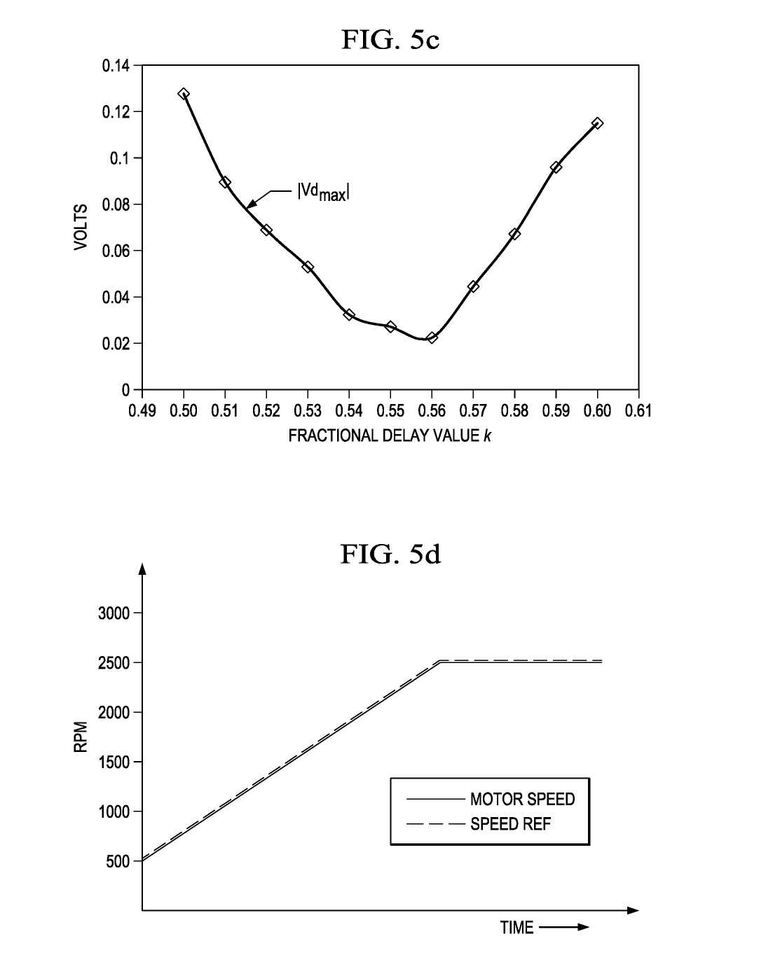

FIGS. 5a and 5b illustrate an example of the results of the process of FIG. 4a for trial fractional delay values ranging from k=0.5 to k=0.6 in steps of 0.01. FIG. 5a is a plot of the external control signal \dot{θ}ref indicating the desired speed of motor M, as input to speed controller 30 over the duration of process 54. As indicated in FIG. 5a, the speed of motor M is ramped up over time from 500 RPM to 2500 RPM. FIG. 5b, which is aligned in time with FIG. 5a, illustrates the metric of the observed feedback voltage signal Vd over the duration of the ramping of the speed of motor M, for each of the trial fractional delay values k analyzed in this example. It is, of course, not surprising that the magnitude of feedback voltage signal Vd increases with increasing motor speed, considering that the error resulting from an inaccurate prediction of rotor position will be larger at higher rotor velocity. As evident from this FIG. 5b, the different trial values of fractional delay value k exhibit different Vd magnitudes at the terminal motor speed of 2500 RPM. In this embodiment, a lower magnitude of voltage feedback signal Vd indicates that the prediction of delay-compensated rotor position estimate \hat{θ}[n+1+k] more closely aligns with the actual d axis (i.e., rotor flux position) exhibited at motor M. For the example of FIG. 5b, fractional delay value k=0.55 provides the lowest voltage feedback magnitude |Vd| at the motor speed of 2500 RPM, among this set of trial fractional delay values, and would be the fractional delay value k selected in process 60.

Alternatively, it is contemplated that selection process 60 may include interpolation or a statistical approach to select a fractional delay value k other than those specifically applied in the operation of motor M in process 54. Such a statistical approach or some other multivariable technique will be particularly useful if more than one feedback signal is monitored and stored in processes 54, 56. It is contemplated that these and other alternative approaches to selection process 60 will be apparent to those skilled in the art having reference to this specification.

Following selection of the suitable fractional delay value k in process 60, motor M is then operated as appropriate for its desired application in process 62, applying a delay-compensated rotor position estimate \hat{θ}[n+1+k] incorporating the fractional delay value k selected in process 60 to inverse Park transform function 35.

Various alternatives to this embodiment are contemplated. For example, it is contemplated that decision 57 may alternatively be performed by analyzing the metric of voltage feedback signal magnitude |Vd| obtained for each fractional delay value k as they are acquired. According to this alternative, decision 57 compares each new voltage feedback signal magnitude |Vd| as received with previous values to determine whether the estimated rotor position error is increasing from a minimum value. Referring to FIG. 5b, if the trial fractional delay values k are iteratively increased from k=0.5, decision 57 according to this alternative would detect decreases in voltage feedback signal magnitude |Vd| from k=0.5 to k=0.55, but then detect increases in that magnitude as fractional delay value k increases from 0.55. In this approach, decision 57 could terminate the iteration loop (i.e., return a “no” result) upon detecting one or more trial fractional delay values k yielding a higher magnitude in the monitored feedback signal from a minimum value.

The process described above relative to FIG. 4a considers the magnitude of the feedback signal at a single motor speed (e.g., 2500 RPM) over a range of trial fractional delay values. FIG. 4b illustrates an alternative method of identifying an optimum fractional delay value k, with similar processes as those described above relative to FIG. 4a shown by the same reference numerals. In the embodiment of FIG. 4b, delay selection process is initiated in process 50, followed by initialization of the trial fractional delay value k in process 52, both in the same manner as described above relative to FIG. 4a.

In process 54′, however, the motor control system is operated to drive motor M at varying speeds, for example sweeping from a slow speed to a higher speed such as up to its rated speed. At each of these motor speeds in process 54′, delay compensator function 40 applies a delay-compensated rotor position estimate \hat{θ}[n+1+k] with fractional delay value k at its current trial value, beginning with the value initialized in process 52. And at each of a number of motor speeds, or essentially continuously over all of the motor speeds used in process 54′, one or more of the feedback signals involved in the control of motor M during its operation are monitored by delay selector function 42. In this embodiment, however, a maximum value of the monitored feedback signal or signals over the range of motor speeds of process 54′ is stored in memory (e.g., data memory 24d) in association with the corresponding trial fractional delay value k, in process 56′. For example, if the metric signal monitored during process 54′ is feedback voltage signal Vd from Park transform 47b, process 56′ will store a value |Vdₘₐₓ|, i.e. the maximum magnitude of feedback voltage Vd detected for that trial fractional delay value k over the range of motor speeds. The trial fractional delay values k are iterated over the desired range in the desired manner by way of decision 57 and incrementing process 58, as described above, until all of the trial fractional delay values k have been applied and monitored.

According to this embodiment, selection process 60′ selects an optimum value of fractional delay k as that having an extreme value of the metric signal. In this case, the extreme value is the minimum maximum value of the feedback signal or signals monitored during process 54′. For example, if the monitored feedback signal is feedback voltage Vd as described above, process 60′ identifies the trial fractional delay value k that exhibited the lowest maximum magnitude |Vdₘₐₓ| over the range of motor speeds of process 54′ (i.e., the value k associated with min |Vdₘₐₓ|). FIG. 5c illustrates the variation of maximum magnitude of |Vdₘₐₓ| with fractional delay value k for the results shown in FIG. 5b. These data indicate that fractional delay value k=0.56 would be selected as an optimum value by selection process 60′ according to this embodiment.

Again, following selection process 60′, the motor control system would operate motor M in the normal manner in process 62, applying the delay-compensated rotor position estimate \hat{θ}[n+1+k] to inverse Park transform function 35 corresponding to the fractional delay value k selected in process 60′.

FIG. 5d illustrates the observed operation of a motor operated using a control algorithm corresponding to that of this embodiment of the invention, for the example of a ramped increase in motor frequency from 500 RPM to 2500 RPM. As shown in this example, the motor speed closely matches the speed requested by way of the speed reference signal to an observed error in motor frequency on the order of 5 RPM over the full range of the ramped increase. As compared with the conventional operation illustrated in FIG. 1d, no oscillation due to phase error in the motor drive signals, and the resulting over-correction, occurs according to this embodiment, even at the higher rotational rate.

These embodiments, and alternatives thereto and variations thereof, are capable of providing important advantages in the control of electric motors, such as permanent magnet synchronous motors and AC induction motors. As noted above, these embodiments enable improved accuracy in estimates of rotor position as used in field-oriented control of those motors and machines, such that the response of the motor to applied control signals is significantly improved, especially at high operating speeds. In some cases, motors may be operated at speeds beyond which conventional motor control systems would be unstable. These embodiments are capable of efficient implementation into modern FOC control architectures, without requiring additional external components, and are contemplated to be compatible with existing motor control systems.

While one or more embodiments have been described in this specification, it is of course contemplated that modifications of, and alternatives to, these embodiments, such modifications and alternatives capable of obtaining one or more of the advantages and benefits of this invention, will be apparent to those of ordinary skill in the art having reference to this specification and its drawings. It is contemplated that such modifications and alternatives are within the scope of this invention as subsequently claimed herein.

1. A method of controlling the operation of a multiphase AC electric motor, comprising:
for each of a plurality of trial fractional delay times, generating pulse-width-modulated drive signals for phases of the motor by performing a plurality of operations comprising:
producing a metric signal responsive to a sensed state of the motor;
generating a rotor position estimate at the trial fractional delay time in a next sample period responsive to the metric signal;
storing a magnitude value for the metric signal in association with the trial fractional delay time;
generating at least one control signal responsive to the metric signal and to at least one input signal;
responsive to the rotor position estimate at the fractional delay time in the next sample period, applying a transform to the control signal to produce output control signals; and
generating the pulse-width-modulated drive signals for each of the phases of the motor responsive to the output control signals;
from the stored metric signal magnitude values, selecting a fractional delay time associated with an extreme magnitude value of the metric signal; and
then repetitively generating pulse-width-modulated drive signals for phases of the motor by applying the transform to the control signal responsive to rotor position estimates at the selected fractional delay time.

2. The method of claim 1, wherein the metric signal comprises at least one feedback signal responsive to a sensed state of the motor;
and further comprising:
estimating rotor speed and rotor position of the motor at a first sample period responsive to the at least one feedback signal;
wherein the step of generating a rotor position estimate at the trial fractional delay time in a next sample period is responsive to the estimated rotor speed and rotor position at the first sample period.

3. The method of claim 1, wherein the metric signal comprises at least one feedback signal responsive to a sensed state of the motor;
and further comprising:
measuring rotor speed and rotor position of the motor at a first sample period;
wherein the step of generating a rotor position estimate at the trial fractional delay time in a next sample period is responsive to the measured rotor speed and rotor position at the first sample period.

4. The method of claim 1, wherein the at least one control signal comprise a direct phase control signal and a quadrature phase control signal;
wherein the metric signal comprises a direct phase feedback signal and a quadrature phase feedback signal;
and wherein the step of applying a transform comprises:
performing an inverse Park transform of the direct phase control signal and a quadrature phase control signal at the current rotor position estimate at the trial fractional delay time in the next sample period to produce a plurality of phase control signals;
then generating the pulse-width-modulated drive signals from the plurality of phase control signals.

5. The method of claim 1, further comprising:
aligning the pulse-width-modulated drive signals with one another at a selected time within the next sample period.

6. The method of claim 5, wherein the plurality of trial fractional delay times each include a delay corresponding to an aligning step.

7. The method of claim 1, wherein a storing step stores, for each trial fractional delay time, a metric signal magnitude value corresponding to a steady-state magnitude of a feedback signal at a selected motor speed.

8. The method of claim 7, wherein the selected motor speed is a rated speed of the motor.

9. The method of claim 1, wherein the step of generating pulse-width-modulated drive signals for each of the plurality of trial delay times further comprises:
monitoring the metric signal magnitude over a plurality of motor speeds.

10. The method of claim 9, wherein the metric signal corresponds to an error between the sensed state of the motor and a desired state for the motor;
wherein a storing step stores, for each trial fractional delay time, a metric signal magnitude value corresponding to a maximum magnitude of the metric signal over the plurality of motor speeds;
and wherein the selecting step selects a delay time having a minimum maximum magnitude of the metric signal.

11. A controller for a multiphase AC electric motor, comprising:
control circuitry, for generating a direct phase control signal and a quadrature phase control signal responsive to at least one input signal and to direct and quadrature phase metric signals;
feedback circuitry, for producing the direct and quadrature phase metric signals for a first sample period responsive to electrical values received from at least one sensor at the motor;
circuitry for generating signals corresponding to rotor position and rotor velocity for the first sample period;
a delay compensator function, for generating a rotor position estimate signal for a fractional delay time in a next sample period responsive to the rotor position and rotor velocity for the first sample period; and
a transform function, for generating output drive signals for a plurality of phases of the motor, responsive to the direct phase and quadrature phase control signals, and to the rotor position estimate signal for the next sample period; and
a delay selector function, for selecting the fractional delay time in the next sample period, the selected fractional delay time having an extreme magnitude value of the metric signal among a plurality of trial fractional delay times.

12. The controller of claim 11, wherein generating circuitry comprises:
an estimator function, for generating estimates of rotor position and rotor velocity for the first sample period responsive to the direct and quadrature phase metric signals;
and wherein the delay compensator function generates a rotor position estimate signal for a fractional delay time in a next sample period responsive to the estimate of rotor position and rotor velocity for the first sample period.

13. The controller of claim 11, wherein the generating circuitry comprises:
sensors for measuring rotor position and rotor velocity for the first sample period;
and wherein the delay compensator function generates a rotor position estimate signal for a fractional delay time in a next sample period responsive to the measured rotor position and rotor velocity for the first sample period.

14. The controller of claim 11, further comprising:
a three-phase inverter for driving three power phase signals for application to the motor in response to the output drive signals.

15. The controller of claim 11, wherein the delay selector function and at least one of the control circuitry, feedback circuitry, generating circuitry, delay compensator function, and transform function, are comprised by:
a programmable processor unit; and
program memory storing program instructions that, when executed, cause the processor unit to select the fractional delay time in the next sample period by performing a plurality of operations comprising:
for each of a plurality of trial fractional delay times, generating the output drive signals by performing a plurality of operations comprising:
generating a rotor position estimate at the trial fractional delay time in a next sample period responsive to at least one of the direct and quadrature phase metric signals;
storing a metric signal magnitude value for the trial fractional delay time;
responsive to the rotor position estimate at the fractional delay time in the next sample period, applying a transform to the direct and quadrature phase control signals to produce output control signals; and
generating the output drive signals for each of the phases of the motor responsive to the output control signals; and
from the stored feedback signal magnitude values, selecting a fractional delay time having an extreme magnitude value of the metric signal.

16. The controller of claim 15, wherein the operation of applying a transform comprises:
performing an inverse Park transform of the direct and quadrature phase control signals at the rotor position estimate at the trial fractional delay time in the next sample period to produce a plurality of phase control signals as the output control signals;
and wherein the operation of generating the output drive signals comprises:
then generating pulse-width-modulated drive signals from the plurality of phase control signals.

17. The controller of claim 16, wherein the plurality of operations further comprises:
aligning the pulse-width-modulated drive signals with one another at a selected time within the next sample period;
and wherein the plurality of trial fractional delay times each include a delay corresponding to an aligning step.

18. The controller of claim 16, wherein the storing operation stores, for each trial fractional delay time, a metric signal magnitude value corresponding to a steady-state magnitude of a feedback signal at a selected motor speed.

19. The controller of claim 18, wherein the selected motor speed is a rated speed of the motor.

20. The controller of claim 16, wherein the metric signal corresponds to an error between the sensed state of the motor and a desired state for the motor;
wherein the storing operation stores, for each trial fractional delay time, a metric signal magnitude value corresponding to a maximum magnitude of the metric signal over a plurality of motor speeds;
and wherein the selecting operation selects a delay time having a minimum maximum magnitude of the metric signal.
